(19) United States
(12) Patent Application Publication
(10) Pub. No.: US 2013/0152116 A1
(43) Pub. Date: Jun. 13, 2013

(54) MONITOR WITH RATINGS SURVEY CAPABILITY

(71) Applicant: Chin-Tu TSAI, Taoyuan County (TW)

(72) Inventor: Chin-Tu TSAI, Taoyuan County (TW)

(73) Assignee: HERAN CO., LTD., Taoyuan County (TW)

(21) Appl. No.: 13/449,836

(22) Filed: Apr. 18, 2012

(30) Foreign Application Priority Data
Dec. 12, 2011 (TW) 100223412

(51) Int. Cl. H04N 21/442

(52) U.S. Cl. 725/14

(57) ABSTRACT

A monitor with ratings survey capability is provided, including a monitor, characterized in that the monitor is equipped with a data collecting means and the data collecting means is connected to a signal resource for collecting viewing history of the monitor during a period from monitor start-up to monitor shut-down. The data collecting means can transmit the collected viewing history back so that the monitor is provided with a function of ratings survey for the convenience of ratings survey of various programs, time slot ratings survey, or recording viewing habit of the family.

### BACKGROUND OF THE INVENTION

1. Field of the Invention

The present invention is related to a monitor with ratings survey capability, and more particular to a monitor having data collector to allow the monitor having a function of ratings survey, applicable for any type of TV, monitor or similar apparatus.

2. Description of Related Art

Since the starting of TV broadcasting, the number of channels grew from a few to over a hundred channels, providing the audience with more selections. Consequently, the ratings of a TV program drops from as high as almost 100% in early days to the recent 10% and this is considered a hit TV program.

The current ratings survey in Taiwan is performed by rating survey companies, often through the means of questionnaires or telephone interviews. The existing means is at best a representation of a very small percentage of the viewing population and cannot show the true condition of television watching. Therefore, some rating survey companies perform ratings survey through means of installing an external recording device to the TV set to automatically record the playing condition of the TV set at every second of 24 hours of the day. Then, at midnight, the recording device uses the telephone line to transmit the daily recorded data to the rating survey company for analysis, where the statistic theorems are used for estimating the ratings. However, the above means usually takes at least a day to transmit the data and several days to analyze and obtain the ratings result. This makes of the result often subjecting to questions of manipulation or distortion.

In view of the aforementioned disadvantages, the present invention aims to provide a monitor with ratings survey capability for easy operation and control by users.

### SUMMARY OF THE INVENTION

Accordingly, the primary objective of the present invention is to provide a monitor with ratings survey capability, by having an arrangement that comprises data collecting means coupled to a monitor with the data collecting means being connected to a signal source for collecting viewing history of the monitor from monitor start-up to monitor shut-down and the data collecting means being capable of transmitting back the collected viewing history so that the monitor is with ratings survey capability to enhance overall utility.

The secondary objective of the present invention is to provide a monitor with ratings survey capability, by connecting a signal source to a database, and the database providing storage of data of viewing history and performing data analysis of the viewing history so as to provide real-time ratings information of each TV program, programs of a specific time slot, or daily viewing habit of a specific viewer to thereby improve overall convenience of operation.

In order to achieve the foregoing objectives, the present invention provides a monitor with ratings survey capability, which comprises a monitor and is characterized in that: the monitor is equipped with data collecting means. The data collecting means is connected to a signal source so that entire viewing history of the monitor in the time period from monitor start-up to monitor shut-down can be collected through the data collecting means. The data collecting means may transmit collected viewing history back so that the monitor is provided with a function of ratings survey for convenience of ratings survey of each program, all programs during a time slot, or daily viewing habit of a viewer.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be fully understood from the following detailed description and preferred embodiment with reference to the accompanying drawings, in which:

FIG. 1 is a schematic view illustrating an externally add-on data collecting means according to the present invention;

FIG. 2 illustrates a schematic structure diagram of the externally add-on data collecting means according to the present invention;

FIG. 3 illustrates a schematic view of viewer survey interface of the externally add-on data collecting means according to the present invention;

FIG. 4 is a schematic view of viewing a program through the externally add-on data collecting means according to the present invention;

FIG. 5 is a schematic view of an internally built-in data collecting means according to the present invention;

FIG. 6 illustrates a schematic structure diagram of the internally built-in data collecting means according to the present invention;

FIG. 7 illustrates a schematic view of viewer survey interface of the internally built-in data collecting means according to the present invention; and

FIG. 8 is a schematic view of viewing a program through the internally built-in data collecting means according to the present invention.

### DETAILED DESCRIPTION OF THE PREFERRED EMBODIMENTS

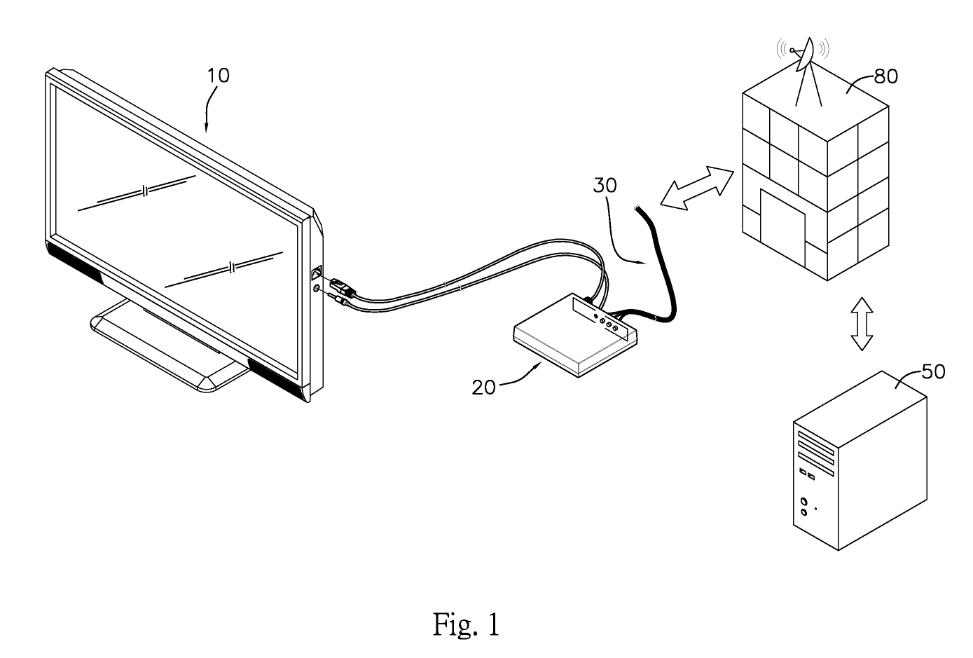

Referring to FIGS. 1-8, the present invention provides a monitor with ratings survey capability, comprising a monitor 10, and characterized in that: the monitor 10 is equipped with a data collecting means 20. The data collecting means 20 is connected to a signal source 30 for collecting entire viewing history 40 of the monitor 10 in a time period from monitor start-up to monitor shut-down through the data collecting means 20. The data collecting means 20 can transmit collected viewing history 40 back so that the monitor 10 is provided with a function of ratings survey.

In addition, the data collecting means 20 is further installed externally to the monitor 10 and is connected to monitor 10 for signal transmission. Alternatively, the data collecting means 20 is internally built in the monitor 10. The data collecting means 20 further comprises a signal processing unit 21, a control unit 22, a data collecting unit 23, and a memory unit 34. The control unit 22 is connected to the signal processing unit 21, the data collecting unit 23, and the memory unit 24. The signal processing unit 21 outputs the input from the signal source 30 to the monitor 10. When the monitor 10 is turned on for viewing, the data collecting unit 23 starts to collect the viewing history 40 of the monitor 10, including recorded data on start-up time, shut-down time, and data of viewing at every second, which are temporarily stored in the memory unit 24. The collected data of viewing history 40 are then transmitted back through the signal source 30 for statistic computation and analysis, wherein the memory unit 24 of the data collecting means 20 further stores a viewer survey interface 25 and the viewer survey interface 25 is able to add, delete and set a plurality of personal data sets 251 of family members, such as name, codename, gender, age, education background, interest, viewing habit, and so on, whereby the monitor 10 may first display the viewer survey interface 25 when turned on to allow the family members to select settings that are transmitted back through the signal source 30. The signal source 30 is further connected to a database 50. The database 50 provides storage of viewing history data 51 and performs viewing history analysis 52. The signal source 30 can be any one of analog TV signal 31, digital TV signal 32, cable TV signal 33, and network TV signal 34. The monitor 10 can be any one of liquid crystal display (LCD), thin-film transistor liquid crystal display (TFT-LCD), organic light-emitting diode (OLED) display, low temperature poly-silicon (LTPS) display, projection display (PD), vacuum fluorescent display (VFD), plasma display panel (PDP), and video monitor, such as TV.

Referring to FIGS. 1-8, the present invention provides a monitor with ratings survey capability. The preferred embodiment of the present invention is realized with a monitor 10, wherein monitor 10 can be any one LCD, TFT-LCD, OLED, LTPS, PD, VFD, PDP, and video monitor. The video monitor is a TV and may function for watching TV programs. The monitor 10 is equipped with a data collecting means 20. The data collecting means 20 is installed externally to the monitor 10 (as shown in FIG. 1) and is connected to the monitor 10 for signal transmission.

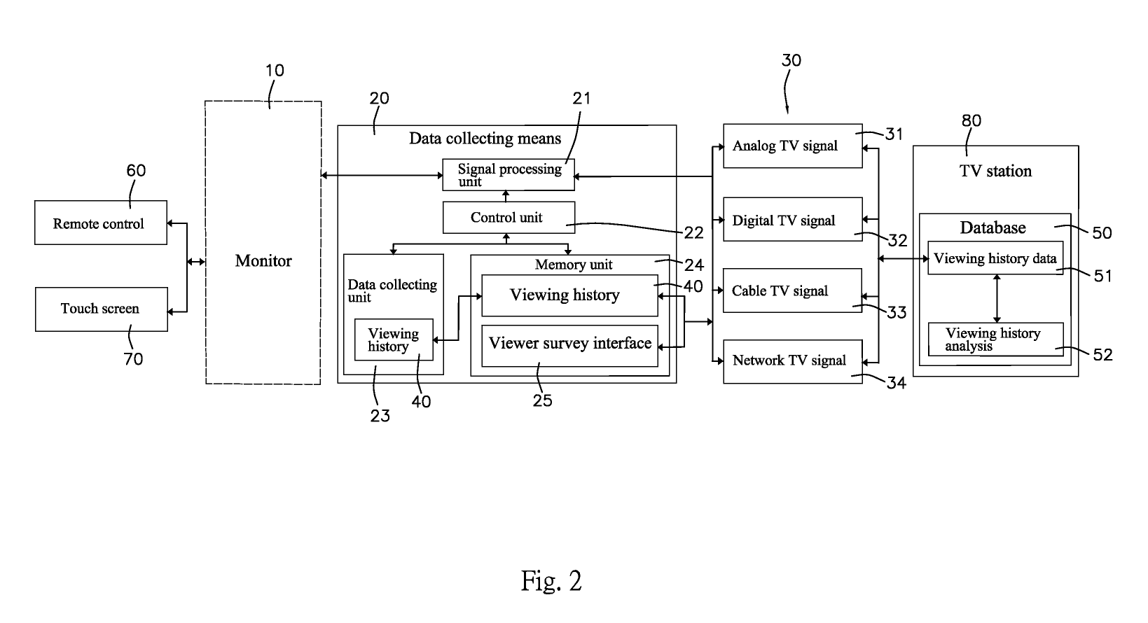

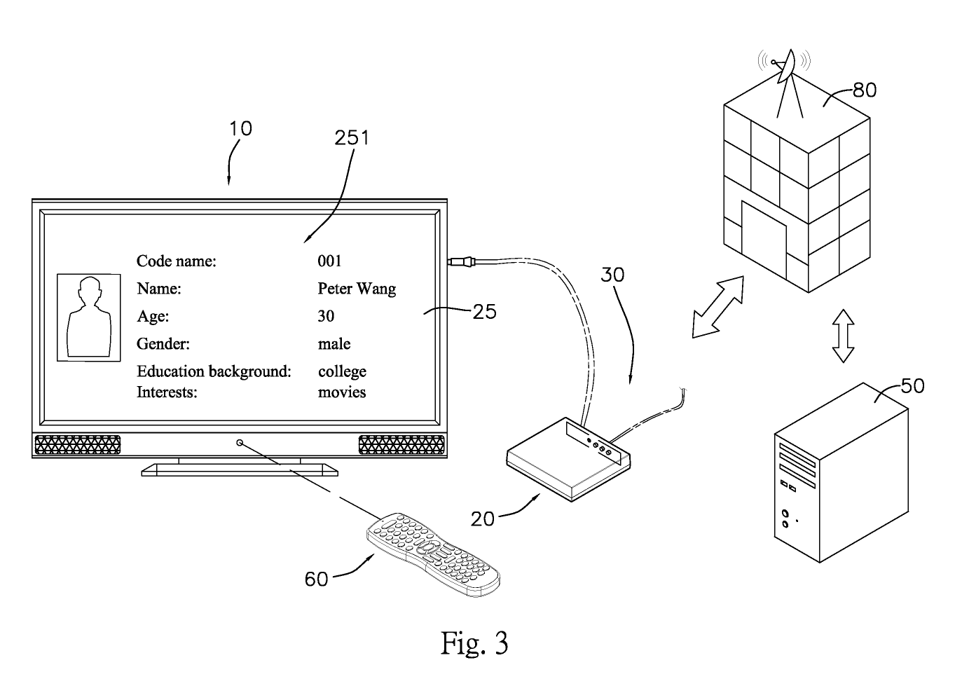

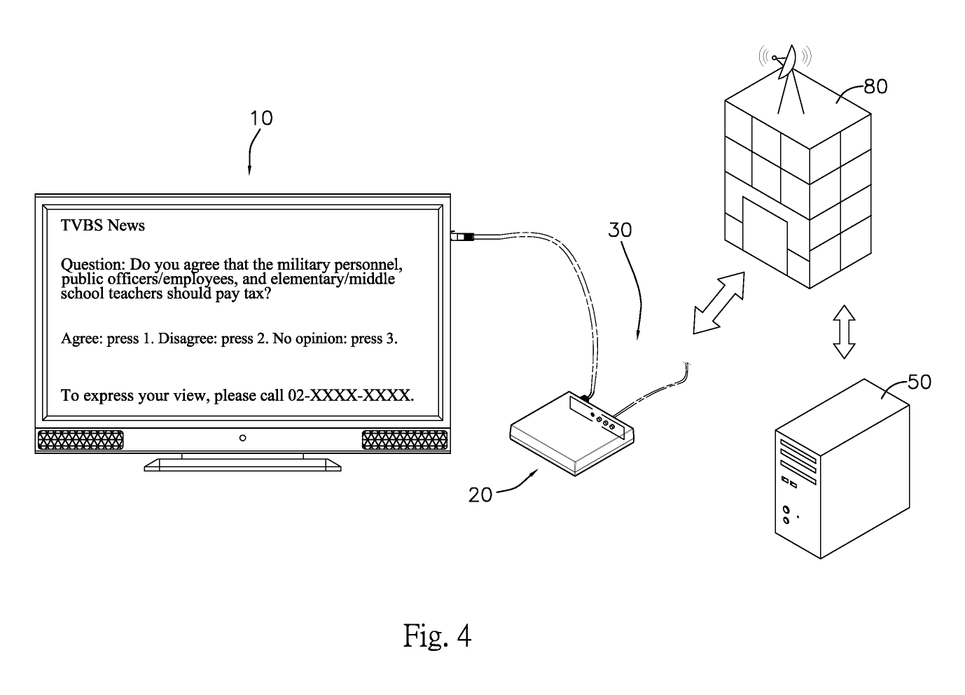

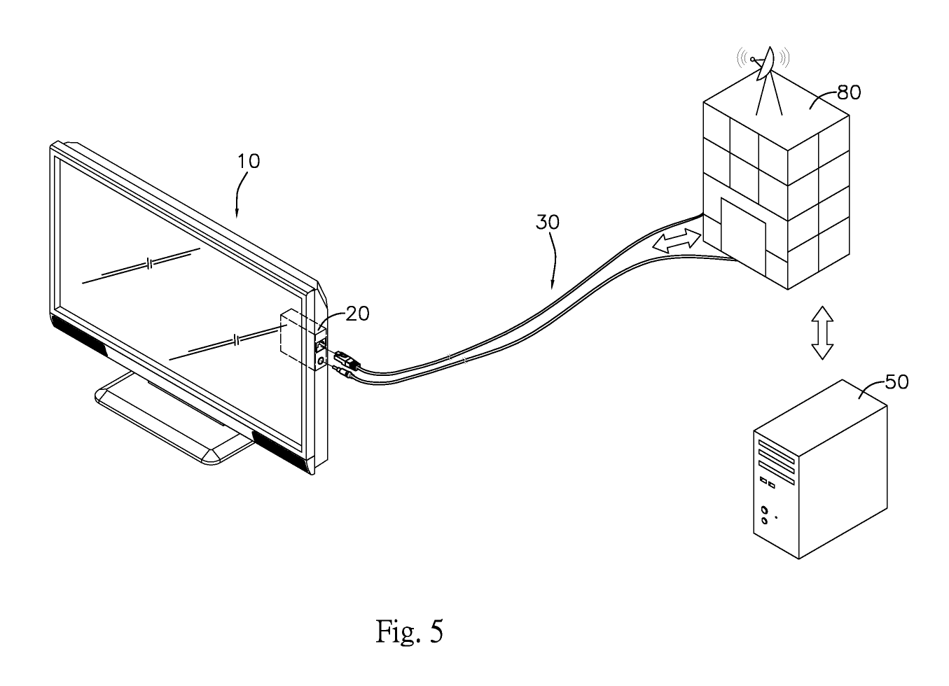

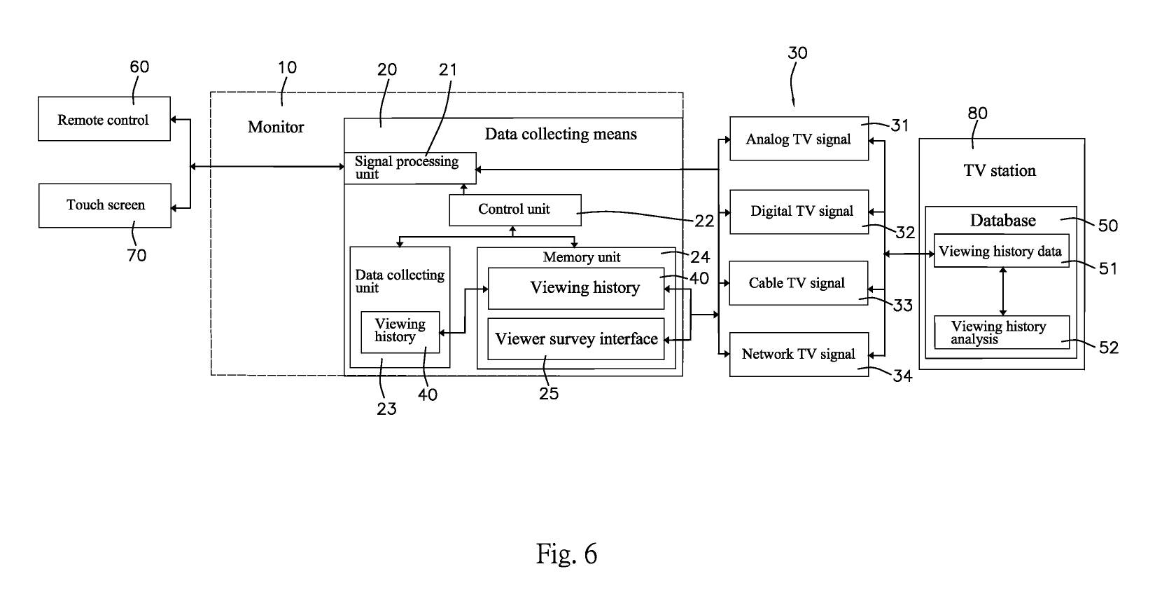

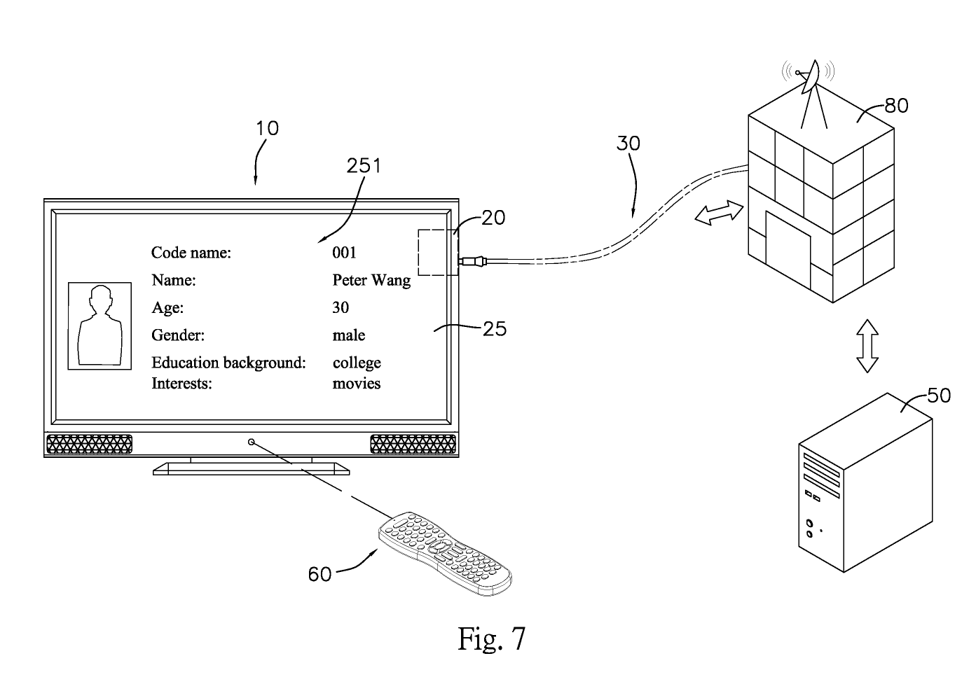

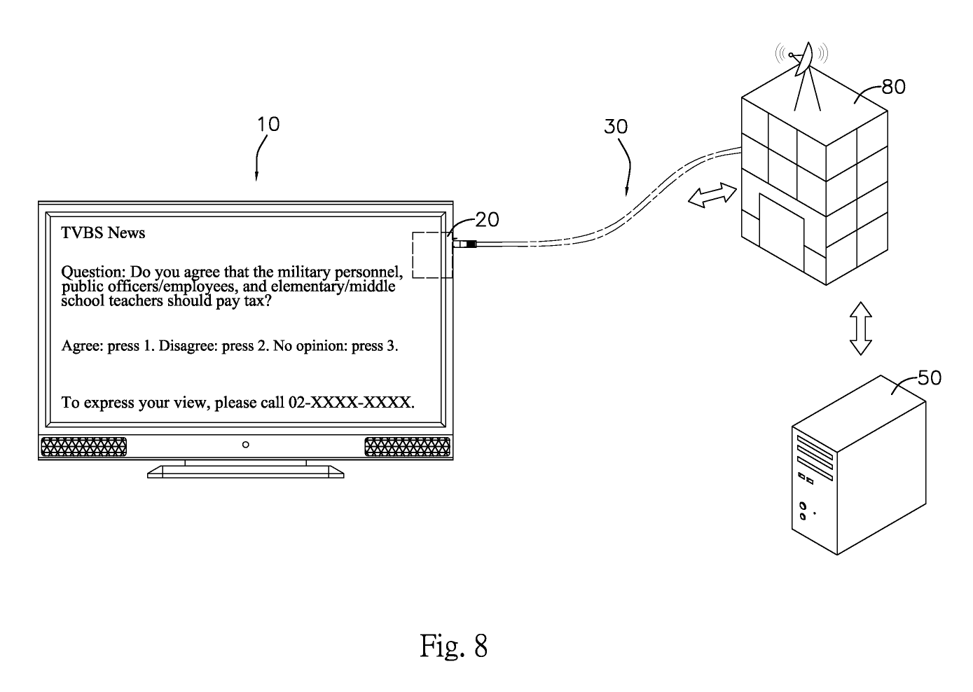

Alternatively, the data collecting means 20 is internally built in the monitor 10 (as shown in FIG. 5). Either equipped externally or built-in internally, the data collecting means 20 is in connection with internal control of the monitor 10. The data collecting means 20 is connected to the source signal 30. The signal source 30 can be any one of analog TV signal 31, digital TV signal 32, cable TV signal 33, and network TV signal 34, so that the data collecting means 20 can receive the contents of TV programs transmitted from different types of signal source 30 and transmit them to the monitor 10. The data collecting means 20 further includes a signal processing unit 21, a control unit 22, a data collecting unit 23, and a memory unit 34. The control unit 22 is connected to the signal processing unit 21, the data collecting unit 23, and the memory unit 24. The signal processing unit 21 outputs the input from the signal source 30 to the monitor 10 (as shown in FIG. 2 or 6). When the monitor 10 is turned on for viewing, the data collecting unit 23 starts to collect the entire viewing history 40 of the monitor 10 (as shown in FIG. 4 or 8), including recorded data of start-up time, shut-down time, and viewing at every second, and also including the number of times of channel switches through a remote control 60, which data are temporarily stored in the memory unit 24. The memory unit 24 of the data collecting means 20 further stores a viewer survey interface 25 and the viewer survey interface 25 is able to add, delete and set a plurality of personal data sets 251 of family members, such as, name, codename, gender, age, education background, interest, viewing habit, and so on, whereby the monitor 10 will first display the viewer survey interface 25 (as shown in FIG. 3 or 7) when turned on to allow the family members to use the remote control 60 to input personal data 251 or to use the monitor 10 equipped with a touch screen 70 to input the personal data 251. Therefore, when turned on, the monitor 10 first displays the viewer survey interface 25 to allow the family members to set personal data 251, which will be stored in memory unit 24 after the operation of setting is completed. Consequently, the viewer only needs to select the personal codename without inputting the personal data again on subsequent viewings. When the data collecting means 20 transmits the collected viewing history 40 through the signal source 30 back to a TV station 80, a cable operator, or a network operator, the personal data 251 of the current viewer will also be transmitted to the TV station 80, the cable operator, or the network operator. The signal source 30 is further connected to a database 50. The database 50 provides storage of viewing history data 51 and performs viewing history analysis 52 (as shown in FIG. 2 or 6) for the convenience of program ratings survey, time slot ratings survey or analysis of viewer's viewing habit. The viewing history analysis 52 can adjust the weighting of the family in ratings computation according to the personal data 251 set through the viewer survey interface 25. The TV station 80, the cable operator, or the network operator can translate the viewing history analysis into ratings report for the program producers, network executives, advertisement buyers or media viewing public to facilitate the understanding of program viewing habit and preference of the public and enable producers or executives to produce programs matching public taste.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A monitor with ratings survey capability, comprising a monitor and characterized in that the monitor is equipped with a data collecting means, the data collecting means being connected to a signal source for collecting a viewing history of the monitor during a period from monitor start-up to monitor shut-down through the data collecting means, the data collecting means transmitting the collected viewing history back so that the monitor is provided with a function of ratings survey.

2. The monitor with ratings survey capability according to claim 1, wherein the data collecting means is installed externally to the monitor and is connected to the monitor for signal transmission.

3. The monitor with ratings survey capability according to claim 1, wherein the data collecting means is internally built in the monitor.

4. The monitor with ratings survey capability according to claim 1, wherein the data collecting means comprises a signal processing unit, a control unit, a data collecting unit, and a memory unit, the control unit being connected to the signal processing unit, the data collecting unit, and the memory unit, the signal processing unit outputting inputted signal source to the monitor, whereby when the monitor is turned on for watching, the data collecting unit starts to collect entire viewing history of the monitor, comprising recorded data of start-up time, shut-down time, and viewing record of every second, which are temporarily stored in the memory unit, the collected of viewing history being then transmitted back through the signal source for statistic computation and analysis.

5. The monitor with ratings survey capability according to claim 2, wherein the data collecting means comprises a signal processing unit, a control unit, a data collecting unit, and a memory unit, the control unit being connected to the signal processing unit, the data collecting unit, and the memory unit, the signal processing unit outputting inputted signal source to the monitor, whereby when the monitor is turned on for watching, the data collecting unit starts to collect entire viewing history of the monitor, comprising recorded data of start-up time, shut-down time, and viewing record of every second, which are temporarily stored in the memory unit, the collected of viewing history being then transmitted back through the signal source for statistic computation and analysis.

6. The monitor with ratings survey capability according to claim 3, wherein the data collecting means comprises a signal processing unit, a control unit, a data collecting unit, and a memory unit, the control unit being connected to the signal processing unit, the data collecting unit, and the memory unit, the signal processing unit outputting inputted signal source to the monitor, whereby when the monitor is turned on for watching, the data collecting unit starts to collect entire viewing history of the monitor, comprising recorded data of start-up time, shut-down time, and viewing record of every second, which are temporarily stored in the memory unit, the collected of viewing history being then transmitted back through the signal source for statistic computation and analysis.

7. The monitor with ratings survey capability according to claim 4, wherein the memory unit of the data collecting means further stores a viewer survey interface, the viewer survey interface being operable to selectively add, delete and set a plurality of personal data sets of family members, the personal data including name, codename, gender, age, education background, interest, and viewing habit, whereby the monitor first displays the viewer survey interface when turned on to allow the family members to select settings that are transmitted back through the signal source.

8. The monitor with ratings survey capability according to claim 1, wherein the signal source is further connected to a database, the database providing storage of viewing history data and performing viewing history analysis.

9. The monitor with ratings survey capability according to claim 1, wherein the signal source is one of analog TV signal, digital TV signal, cable TV signal, and network TV signal.

10. The monitor with ratings survey capability according to claim 1, wherein the monitor is one of LCD, TFT-LCD, OLED, LTPS, PD, VFD, PDP, and TV.

11. The monitor with ratings survey capability according to claim 7, wherein the viewing history analysis adjusts the weighting of the family in ratings computation according to the personal data added, deleted and set through the viewer survey interface.
